(19) United States
(12) Patent Application Publication
(10) Pub. No.: US 2012/0278156 A1
(43) Pub. Date: Nov. 1, 2012

(54) Optimal Trading in Online Loyalty Point Exchanges

(75) Inventors: Ramakrishnan Kannan, Bangalore (IN); Anbazhagan Mani, Bangalore (IN); Karthik Subbian, Bangalore (IN); Vasu Vallabhaneni, Austin, TX (US)

(73) Assignee: International Business Machines Corporation, Armonk, NY (US)

(21) Appl. No.: 13/094,426

(22) Filed: Apr. 26, 2011

(51) Int. Cl. G06Q 30/00

(52) U.S. Cl. 705/14.32

(57) ABSTRACT

A mechanism is provided for completing a loyalty program transaction. The mechanism forms a coalition of a plurality of customers, including the requesting customer. Each customer within the plurality of customers requests to exchange loyalty points for a reward in a loyalty program. Each customer within the plurality of customers participates in a plurality of loyalty programs. Combined loyalty points of the plurality of customers in the plurality of loyalty programs are sufficient to be exchanged for the rewards requested by the plurality of customers. The mechanism further completes a transaction for each customer within the plurality of customers to exchange an amount of loyalty points in a respective one of the plurality of loyalty programs for a reward, such that completing the transactions for the plurality of customers results in a number of residual points. The mechanism further distributes the number of residual points among the plurality of customers.

### BACKGROUND

The present application relates generally to an improved data processing apparatus and method and more specifically to mechanisms for optimal trading in online loyalty point exchanges.

Loyalty programs are common marketing efforts that reward loyal buying behavior that is potentially of benefit to a business. Frequent flyer programs are examples of well known loyalty programs. In most cases, loyalty points gained from one business cannot be converted to loyalty points of different businesses. One may use loyalty points to purchase from a restricted set of loyalty partners that are part of a loyalty agreement between a business and its loyalty partners.

If a customer does not have the required amount of loyalty points for a particular reward at a given time, then the points have no value to the customer at that time. In fact, a customer may have points in several loyalty programs at the same time; however, the customer may not have enough points to redeem for a desired reward in any one loyalty program. Thus, the customer may have unusable points in several loyalty programs, even though the loyalty programs may share common loyalty partners or may have different loyalty partners offering similar rewards.

For example, a customer may have a first number of points in a loyalty program for an electronics retailer, a second number of points in a loyalty program for a soft drink, a third number of points in a loyalty program for a sandwich shop, a fourth number of points in a loyalty program for a clothing store, a fifth number of points in a loyalty program for an athletic shoe retailer, a sixth number of points in a loyalty program for a book store, and a seventh number of points in a loyalty program for a coffee shop. It is not uncommon for a customer to have a modest number of points in each of a large number of loyalty programs. The customer may be very loyal to every one of the vendors or service providers, but the rewards that are attainable for the points in each separate loyalty program may be underwhelming.

As a result of the above disadvantages, loyalty programs are seen by many customers as a nuisance. The low level rewards are not worth the time and effort to manage multiple loyalty programs. The high level rewards appear unattainable. With no easy and practical way to redeem loyalty points, loyal buying behavior goes unrewarded, and the customers are not encouraged to repeat this behavior.

### SUMMARY

In one illustrative embodiment, a method, in a data processing system, is provided for completing a loyalty program transaction. The method comprises forming, by the data processing system, a coalition of a plurality of customers, including the requesting customer. Each customer within the plurality of customers requests to exchange loyalty points for a reward in a loyalty program. Each customer within the plurality of customers participates in a plurality of loyalty programs. Combined loyalty points of the plurality of customers in the plurality of loyalty programs are sufficient to be exchanged for the rewards requested by the plurality of customers. The method further comprises completing, by the data processing system, a transaction for each customer within the plurality of customers to exchange an amount of loyalty points in a respective one of the plurality of loyalty programs for a reward, such that completing the transactions for the plurality of customers results in a number of residual points. The method further comprises distributing, by the data processing system, the number of residual points among the plurality of customers.

In other illustrative embodiments, a computer program product comprising a computer useable or readable medium having a computer readable program is provided. The computer readable program, when executed on a computing device, causes the computing device to perform various ones of and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of and combinations of the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3 is a diagram illustrating a loyalty business process in accordance with an illustrative embodiment;

FIG. 4 illustrates an example loyalty program online interface in accordance with an illustrative embodiment;

FIG. 5 is a flow diagram illustrating operation of a coalition service in accordance with an illustrative embodiment;

FIG. 6 is a block diagram illustrating functional components of a coalition server in accordance with an illustrative embodiment;

FIG. 7 illustrates an example of forming a coalition in accordance with one embodiment;

FIG. 8 is a graph depicting loyalty points to dollar value function in accordance with an illustrative embodiment;

FIG. 9 is a table illustrating the worth of potential coalitions in accordance with an example embodiment;

FIG. 10 illustrates a final transaction in terms of contributed loyalty points and residual points in accordance with an example embodiment; and

FIG. 11 is a flowchart illustrating operation of a coalition transaction for online loyalty point exchange in accordance with an illustrative embodiment.

### DETAILED DESCRIPTION

The illustrative embodiments provide a mechanism for optimal trading in online loyalty point exchanges. If a customer selects a reward for which the customer does not have sufficient points and the customer belongs to multiple loyalty programs, a coalition formation engine in an aggregate server attempts to find a coalition of customers such that customers in the coalition share points from multiple loyalty programs to meet the objectives of the customers. The coalition formation engine determines the points required to achieve the objective of each player and the points available in each loyalty program. The coalition formation engine performs a dollar conversion function to normalize the loyalty points and determines a coalition that achieves the objectives and maximizes residual points. The coalition formation engine presents a transaction to each customer showing details of the coalition including residual points. If all customers in the coalition agree to the terms of the transaction, then the coalition formation engine communicates with each loyalty program to exchange points for rewards to meet the objectives of the customers in the coalition. The coalition formation engine may allocate residual points back to the customers in the form of loyalty points for a loyalty program selected by each customer.

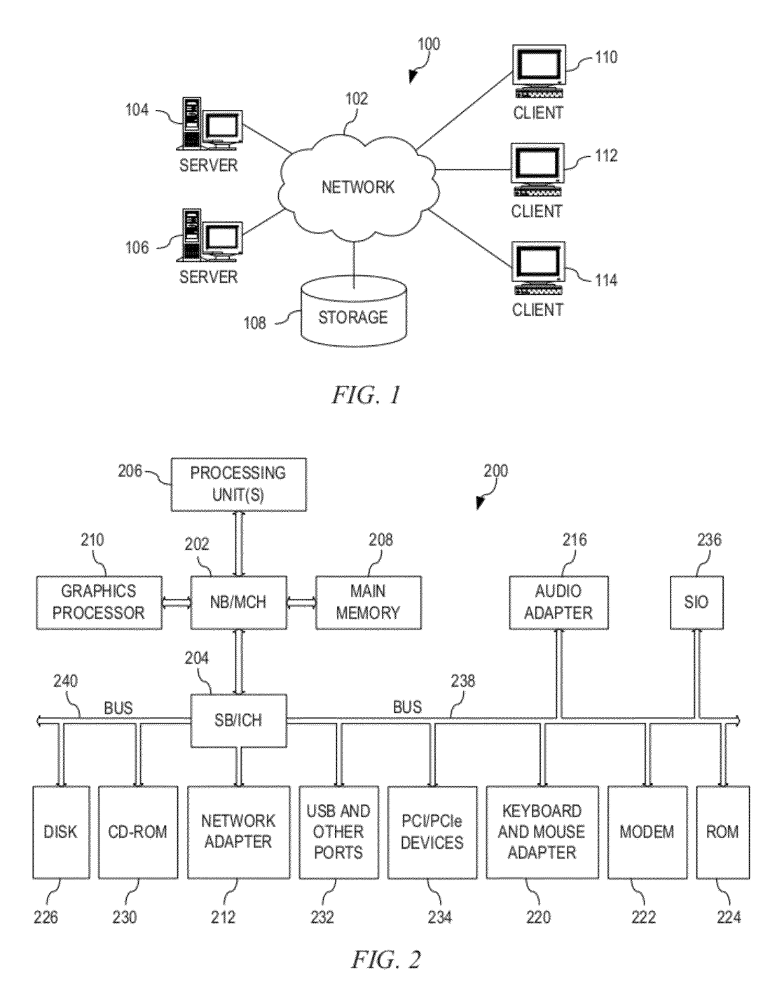

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard t the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7 (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Oracle and/or its affiliates.

As a server, data processing system 200 may be, for example, an eServer System p® computer system, running the Advanced Interactive Executive (AIX®) operating system or the LINUX operating system (IBM, eServer, System p, and AIX are trademarks of International Business Machines Corporation in the United States, other countries, or both, and LIMA is a registered trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

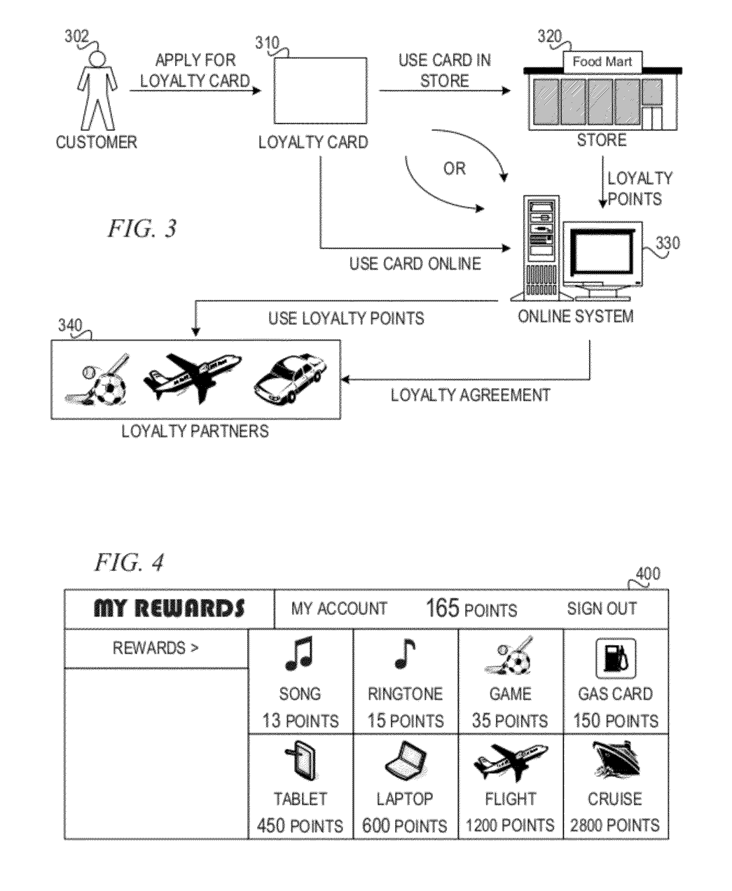

FIG. 3 is a diagram illustrating a loyalty business process in accordance with an illustrative embodiment. Customer 302 applies for a loyalty card 310 to use in store 320. When making purchases in store 320, customer 302 presents loyalty card 310 to the cashier. Based on certain criteria, store 320 issues loyalty points to customer 302. Store 320 communicates the loyalty points to online system 330.

Many stores or services may associate the customer's telephone number or credit card number, for example, with the customer's account. Therefore, customer 302 may make purchases at store 320 that are associated with loyalty card 310 without customer 302 having card 320 in her possession. Instead, customer 302 may tell the cashier her telephone number. Alternatively, customer 302 may earn loyalty points by using a particular credit card.

Stores, services, or vendors may also allow customer 302 to make purchases online directly with online system 330. Customer 302 may enter a card number for card 310 for each transaction or may sign on with a username and password that are associated with card 310.

Customer 302 may manage loyalty points by interacting with online system 330. More particularly, customer 302 may redeem points for rewards provided by store 320 or loyalty partners 340. The loyalty reward program 330 may have a loyalty agreement with loyalty partners 340 such that loyalty partners 340 may offer particular products or services to customer 302 through online system 330. To customer 302, it appears that loyalty points are exchanged directly for products or services; however, loyalty partners 340 are compensated through the loyalty agreement with the business providing the loyalty program, such as store 320.

FIG. 4 illustrates an example loyalty program online interface in accordance with an illustrative embodiment. For example, loyalty reward interface 400 may be a Web page seen by customer 302 when interacting with online system 330 in FIG. 3. As seen in this example, the customer signs into her account and sees that she has 165 loyalty points. Loyalty reward interface 400 may present a plurality of possible rewards, in this case a song download, a phone ringtone, a video game, a gas card, a tablet computer, a laptop computer, a flight, and a cruise.

With 165 points, the customer can redeem loyalty points and receive a song download, a phone ringtone, a video game, or a gas card. However, if the customer does not want those rewards, but instead wants a tablet computer, the 165 loyalty points are not useful to the customer at this particular time. In addition, the customer may have loyalty points in many loyalty programs that are not being used to benefit the customer. The loyal buying behavior of the customer is not being rewarded in a way that is meaningful to the customer. A loyalty program is only beneficial to the business providing the program if it encourages the customer to continue or repeat this pattern of behavior. Also, a loyalty program is only beneficial to a loyalty partner if it generates a revenue stream, which increases greatly if customers are able to redeem their loyalty points.

In accordance with an illustrative embodiment, a coalition service is provided by a third party that permits a more efficient mechanism that can benefit the customer and the retailer, vendor, or service provider, as well as the loyalty partners. The coalition service allows a plurality of customers to share loyalty points from a plurality of loyalty programs in a manner that benefits all customers in the coalition for a transaction.

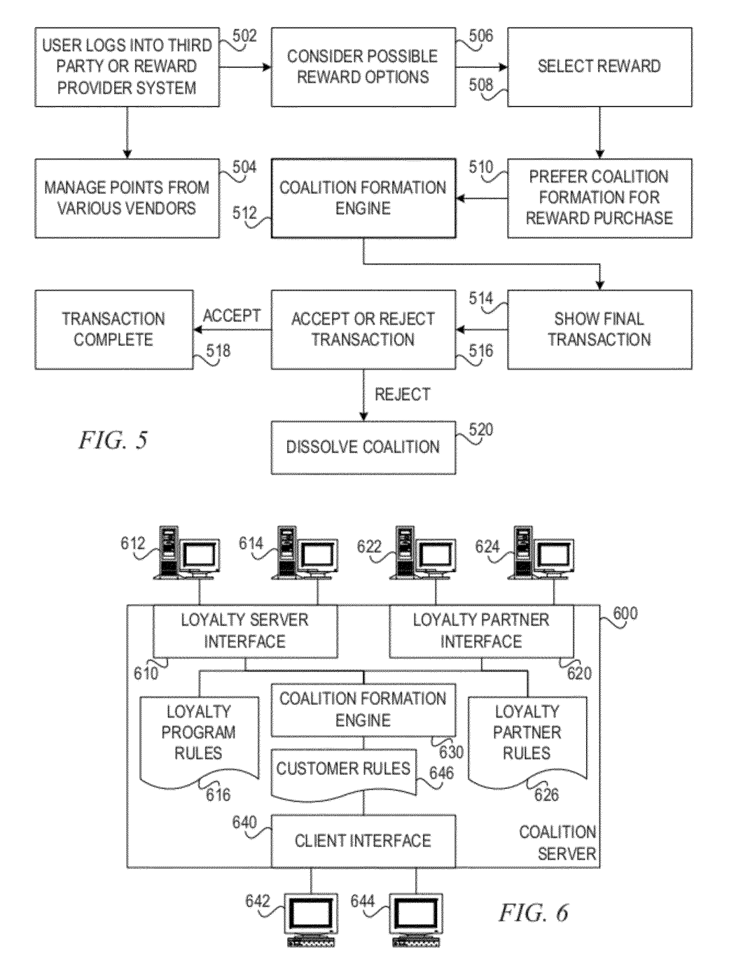

FIG. 5 is a flow diagram illustrating operation of a coalition service in accordance with an illustrative embodiment. The user logs into a third party or reward provider system (block 502). The user may simply log into one of the loyalty programs' Web sites and consider possible reward options (block 506).

Alternatively, the user may log into a third party in block 502 by logging into a Web site on a server of the coalition service, which may aggregate information from various vendors. The user may then manage points from various vendors (block 504). For instance, the user may provide account information, such as user identifiers, passwords, and card numbers, of several loyaltyprograms to the coalition server. In subsequent interactions, the coalition server may present an interface that aggregates the account information, including loyalty point balances, for the plurality of loyalty programs. In addition, the coalition server may provide an aggregate of possible reward options from the various loyalty programs.

Thus, the user considers possible reward options (block 506), possibly including rewards in a plurality of loyalty programs, and selects a reward (block 510). In the depicted embodiment, the user prefers coalition information for the reward purchase (block 510). More specifically, the user may prefer coalition formation if the user does not have enough loyalty points for the reward in that particular loyalty program, although the user may prefer coalition formation for any reward purchase.

A coalition formation engine (block 512) in the coalition server forms a coalition including a plurality of customers and a plurality of loyalty programs. In one embodiment, the coalition formation engine finds a coalition that achieves the objectives of all the customers in the coalition and maximizes residual points. The coalition formation engine may return a coalition immediately, if possible, or may place the user in a queue until a suitable coalition is determined.

When the coalition formation engine finds a coalition that achieves the objectives of the customers and maximizes residual points in block 512, the coalition server shows the final transaction to the user (block 514). The customers must then accept or reject the transaction (bock 516). If any customer in the coalition rejects the transaction, the coalition formation engine dissolves the coalition (block 520). The coalition formation engine may then place the customers back in a queue to wait for the coalition formation engine to propose another coalition (block 512) and transaction (block 514).

If the customers in the coalition accept the transaction in block 516, the coalition server completes the transaction (block 518). The coalition server may complete the transaction by deducting loyalty points from the plurality of loyalty programs, purchasing the rewards from the loyalty partners, determining a number of residual points to return to each of the plurality of customers, and returning the residual points to the plurality of customers in the coalition. The coalition server may return residual points to each customer in loyalty program of the customer's choice or may distribute the residual points among loyalty programs evenly.

FIG. 6 is a block diagram illustrating functional components of a coalition server in accordance with an illustrative embodiment. Coalition server 600 includes a loyalty server interface 610 for communicating with loyalty servers 612, 614, a loyalty partner interface 620 for communicating with loyalty partners 622, 624, and a client interface for interfacing with clients 640. Coalition server 600, loyalty servers 612, 614, and loyalty partners 622, 624 may represent examples of servers 104, 106 in FIG. 1, for example. Clients 642, 644 may represent examples of clients 110, 112, 114 in FIG. 1, for example. Coalition server 600 may communicate with any number of loyalty servers 612, 614, loyalty partners 622, 624, and clients 642, 644 through a network, such as network 102 in FIG. 1, for example.

Clients 642, 644 may communicate with coalition server 600 via client interface 640 to create an account, sign into loyalty programs at loyalty servers 612, 614, view loyalty program account information, and/or purchase rewards using loyalty points. Each loyalty servers 612, 614 may include an application program interface (API) to allow coalition server 600 to interface with loyalty program account information on behalf of clients 642, 644.

Coalition server 600 includes coalition engine 630. When a plurality of customers wish to purchase a reward that requires a coalition with other customers, coalition formation engine 630 attempts to identify a coalition of customers that achieves the objectives of the customers (purchase rewards) and maximizes residual points.

Customers may use clients 642, 644 to generate customer rules 646 that define rules and restrictions for forming coalitions. For example, a customer may define in customer rules 646 that all residual points are to be returned as loyalty points in one loyalty program. Alternatively, a customer may define in customer rules 646 that residual points are to be distributed among loyalty programs. A customer may also define a minimum number of residual points required for a coalition, and any transaction resulting in at least the minimum number of residual points may be automatically approved by that customer.

Businesses may use loyalty servers 612, 614 to generate loyalty program rules 616 that define rules and restrictions for forming coalitions. For example, a business may define in loyalty program rules 616 that only a percentage of loyalty points may be contributed to a coalition. Alternatively, a business may define a number of additional loyalty points to be deducted as a cost for allowing a coalition. A business may also restrict the businesses with which it may be involved in a coalition. For example, a soft drink company may define in loyalty program rules 616 that it will not enter into a coalition involving competing soft drink companies. As another example, a business may define that coalitions may be formed involving a restricted set of loyalty partners.

Loyalty partners 622, 624 may generate loyalty partner rules 626 that define rules and restrictions for forming coalitions. For example, a loyalty partner may limit the rewards that are available to be purchased through a coalition. A loyalty partner may also restrict the other loyalty with which it may be involved in a coalition.

Other customer, loyalty program, and loyalty partner rules may become apparent to a person of ordinary skill in the art, and the above examples are not intended to be exhaustive.

After coalition formation engine 630 forms a coalition that meets loyalty program rules 616, loyalty partner rules 626, and customer rules 646, and all participating customers agree to the transaction, coalition server 600 determines how many loyalty points are to be deducted from each loyally program account and how many residual points are to be returned to each loyalty program account. In an illustrative embodiment, coalition formation engine 630 determines a coalition that satisfies each objective using points from only one loyalty program. Therefore, each loyalty program compensates loyalty partners for the reward according to its loyalty partner agreement.

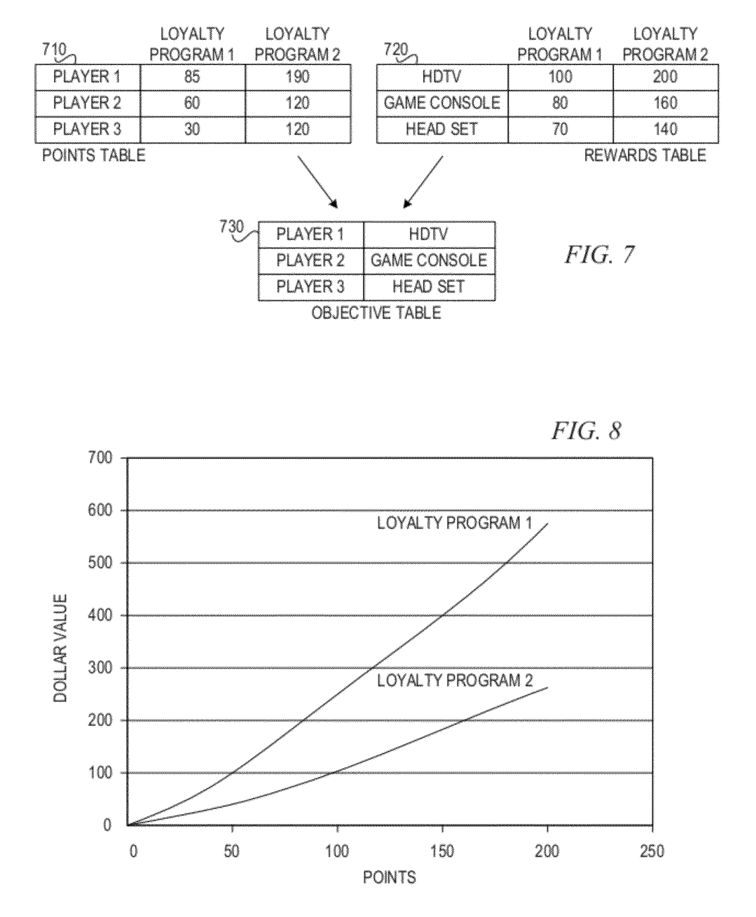

FIG. 7 illustrates an example of forming a coalition in accordance with one embodiment. As seen in points table 710, three players (customers) participate in loyalty programs provided by two loyalty businesses. Player 1 has 85 points in a first loyalty program and 190 points in a second loyalty program. Player 2 has 60 points in the first loyalty program and 120 points in the second loyalty program. Player 3 has 30 points in the first loyalty program and 120 points in the second loyalty program.

As shown in rewards table 720, a high definition television (HDTV) costs 100 points in the first loyalty program and costs 200 points in the second loyalty program. A game console costs 80 points in the first loyalty program and 160 points in the second loyalty program. A head set costs 70 points in the first loyalty program and 140 points in the second loyalty program.

Objective table 730 illustrates the objectives of the players, Player 1 wishes to redeem loyalty points for the HDTV, player 2 wishes to redeem loyalty points for a game console, and player 3 wishes to redeem loyalty points for a head set. As seen in points table 710, each player does not have enough points to purchase the desired reward in either loyalty program; however, each player could purchase the desired reward if the points from both loyalty programs were taken into account.

Furthermore, if one were to combine the players' points, the players collectively would have 175 points in the first loyalty program and 430 points in the second loyalty program. The combined points are more than enough to achieve the objectives of all three players. The coalition formation engine must determine how many points each player contributes to the transaction and receives in return as residual points to make a fair transaction for all players.

For determining a coalition, consider the following notation:

C is the set of players in a coalition.

V is the set of vendors (or point providers)

i is the index on the set of players.

j is the index on the set of vendors.

oᵢⱼ is the points required to achieve the objective of player i with vendor/points.

xᵢⱼ is a binary value indicating whether player i uses vendor/ points in the coalition.

Pᵢⱼ is the points available with player i for vendor j.

Rⱼ is the residual points of vendor j after achieving the objectives of the coalition.

Tⱼ is the total available points to a coalition via vendor j.

fⱼ is the points-to-dollar conversion function for vendor j.

The goal of the coalition formation engine is to achieve the objectives and maximize the residual points, which is represented by the following expression:

$$max {\sum }_{j = 1}^{V} {f}_{j} ( {R}_{j} ) ,$$

achieve objectives and maximize residual points,

s.t.

$${R}_{j} = {T}_{j} - {\sum }_{i ∈ C} {o}_{ij} {x}_{ij} , ∀ j ∈ V ,$$

residual points after achieving objectives,

$${T}_{j} = {\sum }_{i ∈ C} {P}_{ij} , ∀ i ∈ C ,$$

total vendor points for vendor j,

$${\sum }_{j ∈ V} {x}_{ij} = 1 , ∀ i ∈ C ,$$

achieve objective through points from only one vendor,

xᵢⱼ ∈ {01}, ∀ ∈ C, ∀ j ∈ V

Solving the above problem determines whether coalition C can achieve of the objectives. In our example, if the interested coalition is {1,2,3} players, then their objectives are game console, and head set.

As seen in rewards table in FIG. 7, each loyalty points system represents a different currency, where a loyalty point in one loyalty program is not necessarily equal to a loyalty point in another loyalty program. In an illustrative embodiment, the coalition formation engine takes this difference in currency into account by using a points-to-dollar conversion function,

FIG. 8 is a graph depicting loyalty points to dollar value function in accordance with an illustrative embodiment. As seen in FIG. 8, points from loyalty program I are more valuable, in terms of dollars, than points from loyalty program 2. In many cases, the points-to-dollar function may not be linear. In fact, the points-to-dollar function will likely be a convex function. The value of loyalty points in dollars for loyalty program 1 is expressed as follows:

f₁(R₁)=R₁^{1.2}

The value of loyalty points in dollars for loyalty program 2 is expressed as follows:

$${f}_{2} ( {R}_{2} ) = {f}_{1} ( {R}_{2} \text{/} 2 ) = {( \frac{{R}_{2}}{2} )}^{1.2}$$

Solving for he example described above:

max f₁(R₁)+f₂(R₂)

s.t.

x₁₁+x₁₂=1

x₂₁+x₂₂=1

x₃₁+x₃₂=1

x₁₁, x₁₂, x₂₁, x₂₂, x₃₁, x₃₂ ∈ {0,1}

R₁=175−[100x₁₁+80x₂₁+70x₃₁]

R₂=430−[200x₁₂+160x₂₂+140x₃₂]

The output for solving the above is as follows:

x₁₁=x₂₂=x₃₂=1

x₁₂=x₂₁=x₃₁=0

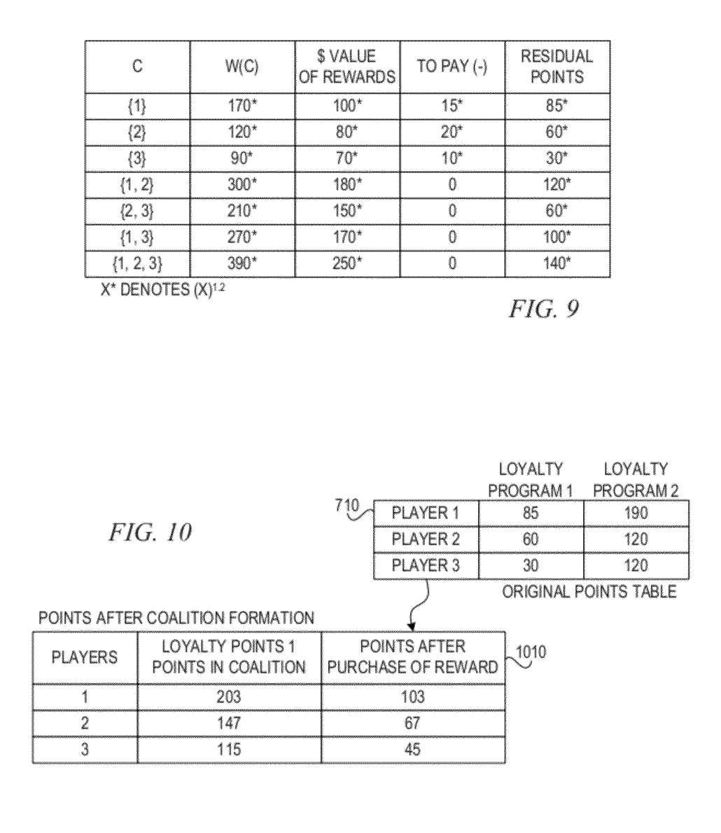

The value of the coalition w(c) equals the dollar value of the rewards achieved minus any payments plus residual vendor points, FIG. 9 is a table illustrating the worth of potential coalitions in accordance with an example embodiment. As seen in the table of FIG. 9, each player by itself has a corresponding value with respect to the value of rewards that it may achieve and residual points, and each combination of players that may form a coalition has a corresponding value with respect to the value of achievable rewards and residual points. As seen in the table of FIG. 9, the coalition with all ⁻three players represents the most valuable coalition, where the value of the rewards achieved (250*) minus points left to pay (0) plus residual points (140*) is 1286 1 (390). Note that X* denotes (X)^{1.2}.

The coalition formation engine uses the concept of marginal contribution from Shapley value to compute the final dollar value amount for each player from which it can make transactions for final settlement for their objectives. The final values for each layer are as follows:

$${φ}_{1} = \frac{1}{6} [ ( 938.74 - 312.62 ) + ( 827.24 - 221.35 ) ] + \frac{1}{3} [ ( 1286.1 - 611.87 ) + 474.83 ] = 588.36$$

$${φ}_{2} = \frac{1}{6} [ ( 938.74 - 474.83 ) + ( 611.87 - 221.35 ) ] + \frac{1}{3} [ ( 1286.1 - 827.25 ) + 312.62 ] = 399.57$$

$${φ}_{3} = \frac{1}{6} [ ( 611.87 - 312.62 ) + ( 827.24 - 474.83 ) ] + \frac{1}{3} [ ( 1286.1 - 938.74 ) + 221.35 ] = 298.18$$

Thus, player 1 contributes the equivalent of $588,36 to the transaction, player 2 contributes the equivalent of $399,57, and player 3 contributes the equivalent of $298.18 to the transaction.

FIG. 10 illustrates a final transaction in terms of contributed loyalty points and residual points in accordance with an example embodiment. In the depicted example, table 1010 shows the points after coalition formation in terms of loyalty program 1 points, Player 1 contributes the equivalent of 175 points and receives 75 points after purchase of the reward. Player 2 contributes the equivalent of 127 points and receives 47 points alter the purchase of the reward, Player 3 contributes the equivalent of 100 points and receives 30 points after the purchase of rewards.

The example shown in FIG. 10 shows the final transaction in terms of points in only one loyalty program. However, there may be many other ways to perform the final transaction, such as converting all points to money and returning residual points to any one loyalty program, perhaps based on the preference of each player. In one example embodiment, the coalition server may distribute the residual dollars among the loyalty programs based on the original ratio of points in the loyalty programs and their respective points-to-dollars conversion functions.

As will be appreciated by one Skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects ⁻that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RIF), etc., or any suitable combination thereof.

Computer program code for carrying out operations for aspects of the present invention may be written in arty combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

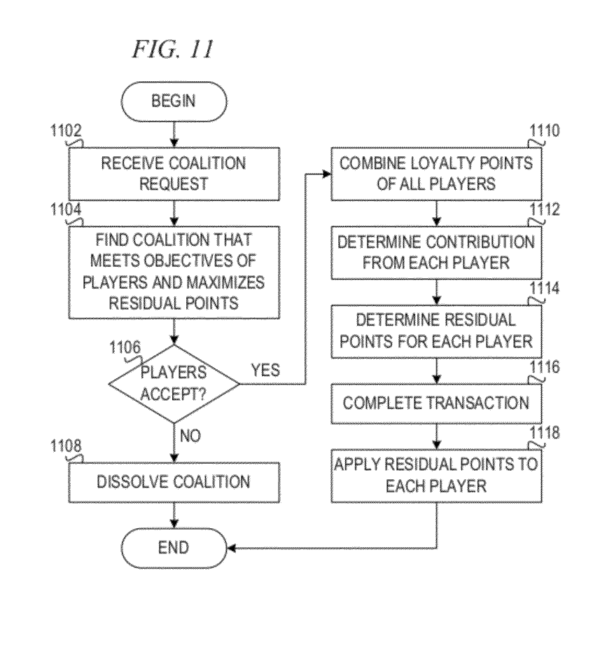

FIG. 11 is a flowchart illustrating operation of a coalition transaction for online loyalty point exchange in accordance with an illustrative embodiment. Operation begins, and a coalition formation engine receives a coalition request from one or more players (customer) (block 1102). The coalition formation engine finds a coalition that meets objectives of players and maximizes residual points (block 1104). The coalition formation engine then determines whether all players in the coalition accept the transaction (block 1106). If at least one player rejects the transaction, the coalition formation engine dissolves the coalition (block 1108), and operation ends.

If all players accept the transaction in block 1106, the coalition formation engine combines the loyalty points of all players (block 1110), determines a contribution from each player (block 1112), and determines residual points for each layer (bock)114), as described above. The coalition formation engine then completes the transaction (block 1116). Then, the coalition formation engine applies the residual points to each player (block 1118), and operation ends.

The flowchart and block diagrams in the figures illustrate the architecture, functionality, and operation of possible implementations of systems, methods and computer program products according to various embodiments of the present invention. This regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will a so be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for optimal trading in online loyalty point exchanges. The mechanism combines loyalty points of a plurality of users in a plurality of loyalty programs to achieve the objectives of the users while maximizing residual points. The mechanism provides a fair trade value, or cash value, of the points, possibly considering a convex nature of the cost-to-cash value function. The mechanism follows rules of fairness, like, linearity, symmetry, and individual rationality.

As noted above, it should be appreciated that the illustrative embodiments may take the form of an entirety hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers% Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for completing a loyalty program transaction, the method comprising:
forming, by the data processing system, a coalition of a plurality of customers, including the requesting customer, wherein each customer within the plurality of customers requests to exchange loyalty points for a reward in a loyalty program, wherein each customer within the plurality of customers participates in a plurality of loyalty programs, and wherein combined loyalty points of the plurality of customers in the plurality of loyalty programs are sufficient to be exchanged for the rewards requested by the plurality of customers;
completing, by the data processing system, a transaction for each customer within the plurality of customers to exchange an amount of loyalty points in a respective one of the plurality of loyalty programs for a reward, such that completing the transactions for the plurality of customers results in a number of residual points; and
distributing, by the data processing system, the number of residual points among the plurality of customers.

2. The method of claim 1, wherein each customer within plurality of customers requests a given reward in a given loyalty program and does not have sufficient loyalty points in the given loyalty program for the given reward.

3. The method of claim 1, wherein forming a coalition comprises:
identifying a coalition that maximizes the number of residual points.

4. The method of claim 1, wherein forming the coalition comprises:
solving for:
$$max {\sum }_{j = 1}^{V} {f}_{j} ( {R}_{j} ) , \\ s . t . \\ {R}_{j} = {T}_{j} - {\sum }_{i ∈ C} {o}_{ij} {x}_{ij} , ∀ j ∈ V , \\ {T}_{j} = {\sum }_{i ∈ C} {P}_{ij} , ∀ i ∈ C , \\ {\sum }_{j ∈ V} {x}_{ij} = 1 , ∀ i ∈ C , and$$
$${x}_{ij} ∈ \{ 0 , 1 \} , ∀ i ∈ C , ∀ j ∈ V ,$$
where C represents the plurality of customers in the coalition, V represents the plurality of loyalty programs, i is an index on the plurality of customers, j is an index on the plurality of loyalty programs, represents the loyalty points required to achieve the objective of customer with loyalty program j points, xᵢⱼ is a binary value indicating whether customer i uses loyalty program j points in the coalition, Pᵢⱼ represents the points available with customer i for loyalty provider j, Rⱼ represents the residual points of loyalty program/ after achieving the objectives of the coalition, Tⱼ represents the total available points to the coalition via loyalty program j, and fⱼ represents a points-to-dollar conversion function for loyalty program j.

5. The method of claim 4, wherein forming the coalition comprises:
converting all loyalty points to a universal unit of value; and
determining a contribution to the coalition in the universal unit of value for each customer within the plurality of customers.

6. The method of claim 5, wherein determining the contribution to the coalition for each customer comprises determining a marginal contribution from Shapley value.

7. The method of claim 5, wherein the universal unit of value is dollars.

8. The method of claim 4, wherein forming the coalition further comprises:
identifying a set of possible coalitions;
determining a worth value for each coalition within the set of possible coalitions; and
selecting the coalition from the set of possible coalitions having a highest worth value,

9. The method of claim 8, wherein determining a worth value for a given coalition comprises:
determining the worth value for the given coalition to be equal to a value of rewards that can be achieved by the given coalition minus an amount to be paid to achieve the rewards plus a value of residual points for the given coalition.

10. The method of claim 1, wherein forming the coalition comprises:
presenting the coalition to the plurality of customers; and
responsive to all of the plurality of customers accepting the coalition, completing the transaction.

11. The method of claim 1, wherein forming the coalition comprises forming the coalition based on at least one of customer rules, loyalty program rules, and loyalty partner rules.

12. A computer program product comprising a computer readable storage medium having a computer readable program stored therein, wherein the computer readable program, when executed on a computing device, causes the computing device to:
form, by the computing device, a coalition of a plurality of customers, including the requesting customer, wherein each customer within the plurality of customers requests to exchange loyalty points for a reward in a loyalty program, wherein each customer within the plurality of customers participates in a plurality of loyalty programs, and wherein combined loyalty points of the plurality of customers in the plurality of loyalty programs are sufficient to be exchanged for the rewards requested by the plurality of customers;
complete, by the computing device, a transaction for each customer within the plurality of customers to exchange an amount of loyalty points in a respective one of the plurality of loyalty programs for a reward, such that completing the transactions for the plurality of customers results in a number of residual points; and
distribute, by the computing device, the number of residual points among the plurality of customers.

13. The computer program product of claim 12, wherein each customer within plurality of customers requests a given reward in a given loyalty program and does not have sufficient loyalty points in the given loyalty program for the given reward.

14. The computer program product of claim 12, wherein forming a coalition comprises:
identifying a coalition that maximizes the number of residual points.

15. The computer program product of claim 12, wherein forming the coalition comprises:
solving for:
$$max {\sum }_{j = 1}^{V} {f}_{j} ( {R}_{j} ) , \\ s . t . \\ {R}_{j} = {T}_{j} - {\sum }_{i ∈ C} {o}_{ij} {x}_{ij} , ∀ j ∈ V , \\ {T}_{j} = {\sum }_{i ∈ C} {P}_{ij} , ∀ i ∈ C , \\ {\sum }_{j ∈ V} {x}_{ij} = 1 , ∀ i ∈ C , and$$
$${x}_{ij} ∈ \{ 0 , 1 \} , ∀ i ∈ C , ∀ j ∈ V ,$$
where C represents the plurality of customers in the coalition, V represents the plurality of loyalty programs, i is an index on the plurality of customers, j is an index on the plurality of loyalty programs, o_{g} represents the loyalty points required to achieve the objective of customer i with loyalty program j points, xᵢⱼ is a binary value indicating whether customer i uses loyalty program j points in the coalition, Pᵢⱼ represents the points available with customer i for loyalty provider j, Rⱼ represents the residual points of loyalty program j after achieving the objectives of the coalition, Tⱼ represents the total available points to the coalition via loyalty program j, and fⱼ represents a points-to-dollar conversion function for loyalty program j.

16. The computer program product of claim 15, wherein forming the coalition comprises:
converting all loyalty points to a universal unit of value; and
determining a contribution to the coalition in the universal unit of value for each customer within the plurality of customers.

17. The computer program product of claim 15, wherein forming the coalition further comprises:
identifying a set of possible coalitions;
determining a worth value for each coalition within the set of possible coalitions; and
selecting the coalition from the set of possible coalitions having a highest worth value.

18. The computer program product of claim 12, wherein the computer readable program is stored in a computer readable storage medium in a data processing system and wherein the computer readable program was downloaded over a network from a remote data processing system.

19. The computer program product of claim 12, wherein the computer readable program is stored in a computer readable storage medium in a server data processing system and wherein the computer readable program is downloaded over a network to a remote data processing system for use in a computer readable storage medium with the remote system.

20. An apparatus, comprising:
a processor; and
a memory coupled to the processor, wherein the memory comprises instructions which, when executed by the processor, cause the processor to:
form, by the computing device, a coalition of a plurality of customers, including the requesting customer, wherein each customer within the plurality of customers requests to exchange loyalty points for a reward in a loyalty program, wherein each customer within the plurality of customers participates in a plurality of loyalty programs, and wherein combined loyalty points of the plurality of customers in the plurality of loyalty programs are sufficient to be exchanged for the rewards requested by the plurality of customers;
complete, by the computing device, a transaction for each customer within the plurality of customers to exchange an amount of loyalty points in a respective one of the plurality of loyalty programs for a reward, such that completing the transactions for the plurality of customers results in a number of residual points; and
distribute, by the computing device, the number of residual points among the plurality of customers.
